(19) United States
(12) Patent Application Publication
(10) Pub. No.: US 2014/0048541 A1
(43) Pub. Date: Feb. 20, 2014

(54) REMOVABLE FUEL TANK

(71) Applicant: Jeff Pirtle, Collinsville, IL (US)

(72) Inventor: Jeff Pirtle, Collinsville, IL (US)

(21) Appl. No.: 13/971,526

(22) Filed: Aug. 20, 2013

Related U.S. Application Data
(60) Provisional application No. 61/691,125, filed on Aug. 20, 2012.

(51) Int. Cl. B60K 15/03; B60K 15/073

(52) U.S. Cl. CPC B60K 15/03006; B60K 15/073
USPC 220/562; 29/428

(57) ABSTRACT

A removable fuel tank for a fuel powered vehicle, such as a lawn mower. The fuel tank may be removed from the vehicle and filled with fuel. Then the fuel tank may be mounted to the vehicle by a mounting component. A fuel output of the fuel tank may be connected to a fuel input on the vehicle. Therefore, the removable fuel tank may provide fuel for the vehicle to run.

### CROSS-REFERENCE TO RELATED APPLICATION

This application claims the benefit of priority of U.S. provisional application No. 61/691,125, filed Aug. 20, 2012, the contents of which are herein incorporated by reference.

### BACKGROUND OF THE INVENTION

The present invention relates to removable fuel tank and, more particularly, to a removable fuel tank that connects with a fuel powered vehicle.

A lawn mower is a machine that uses a revolving blade or blades to cut a lawn at an even height. A riding lawn mower may include a seat and controls, in which a user literally rides on the machine. Most use the horizontal rotating blade system, though usually with multiple blades. A common form of ride-on mower is the lawn tractor. These are usually designed to resemble a small agricultural tractor, with the cutting deck mounted amidships between the front and rear axles.

Currently, it is physically challenging for most users to fill a gas tank on a riding mower with gasoline. Even if the user is careful, there is a risk of spilling gasoline, given that some of the tanks are large tanks and require a large amount of gasoline. Further, it may be difficult for some people to lift and support a heavy gas tank while refueling the lawn mower.

As can be seen, there is a need for a removable tank from a lawn mower or other fuel powered vehicle.

### SUMMARY OF THE INVENTION

In one aspect of the present invention, a removable fuel tank apparatus comprises: a fuel powered vehicle comprising a fuel input; a mounting component connected to the fuel powered vehicle; and a fuel tank comprising a fuel output, wherein the fuel tank is removably attachable to the mounting component, and wherein the fuel output of the fuel tank is removably attachable to the fuel input of the fuel powered vehicle.

In another aspect of the present invention, a method of attaching a fuel tank to a vehicle comprises: filling a freestanding fuel tank with fuel; attaching the fuel tank to a vehicle; and connecting a fuel output of the fuel tank with a fuel input of the vehicle.

These and other features, aspects and advantages of the present invention will become better understood with reference to the following drawings, description and claims.

### BRIEF DESCRIPTION OF THE DRAWINGS

FIG. 1 is a perspective view of the present invention in use;

FIG. 2 is an enlarged perspective view indicated by line 2-2 of FIG. 1;

FIG. 3 is a detail elevation view of the fuel supply conduit with parts shown in cross-section;

FIG. 4 is an exploded elevation view similar to FIG. 3; and

FIG. 5 is an exploded perspective view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a removable fuel tank for a fuel powered vehicle, such as a lawn mower. The fuel tank may be removed from the vehicle and filled with fuel. Then the fuel tank may be mounted to the vehicle by a mounting component. A fuel output of the fuel tank may be connected to a fuel input on the vehicle. Therefore, the removable fuel tank may provide fuel for the vehicle to run.

The present invention may include a removable gas tank for a utility vehicle, such as a lawn mower, or heavy equipment, such as bulldozers, forklifts, tractors, excavators, and the like. In certain embodiments, prior to the machines use, the tank may be removed from the machine, taken to a gas station, filled with gas, and then brought back to the machine and reattached. This operation may be quicker, easier, and safer. There is no spillage of fuel and time is saved since the user no longer has to transfer the gas from the portable gas tank to the gas tank of the machine.

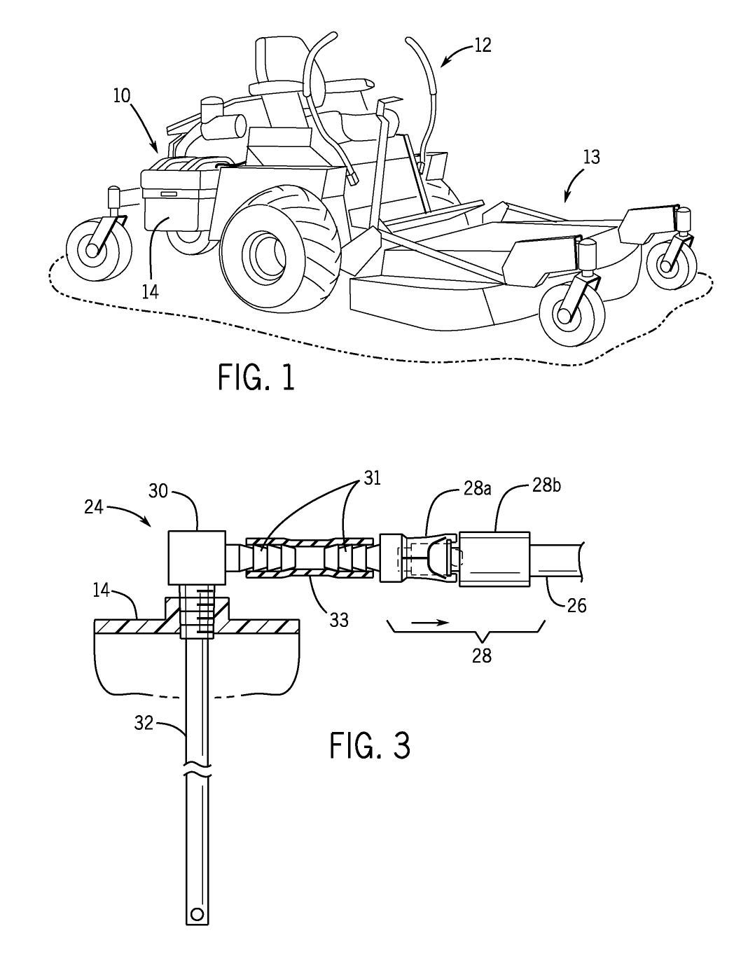

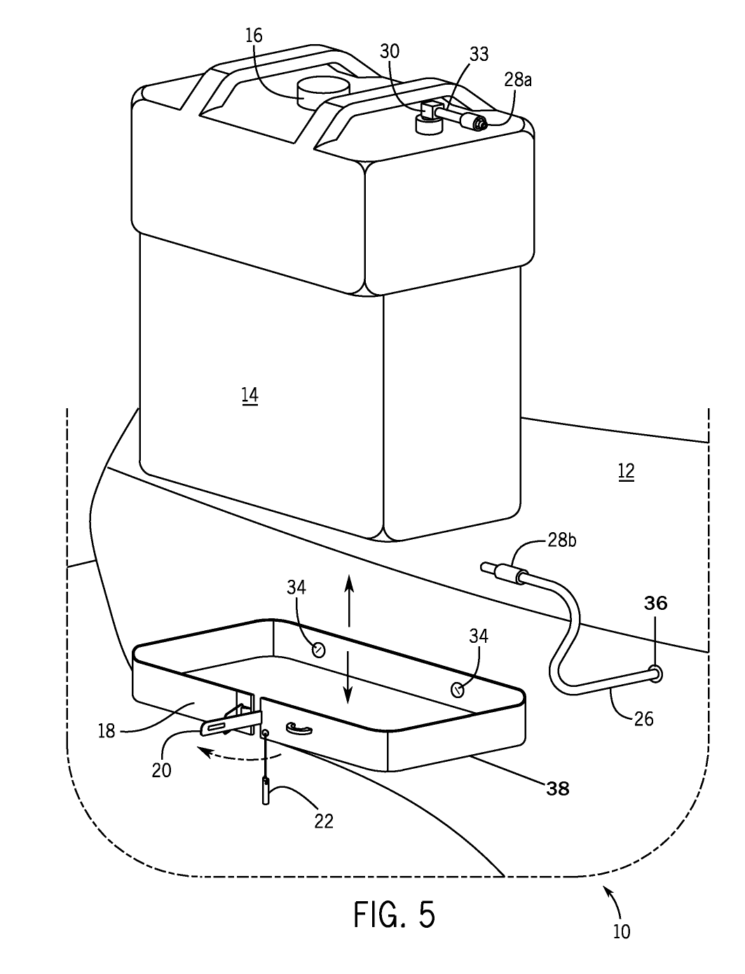

Referring to FIGS. 1 through 5, the present invention may include a removable fuel tank apparatus 10. The removable fuel tank apparatus 10 may include a fuel powered vehicle 12. The fuel powered vehicle 12 may include a fuel input 36. The present invention may further include a mounting component 38. The mounting component 38 may be connected to the fuel powered vehicle 12. The present invention may further include a fuel tank 14 having a fuel output 24. The fuel tank 14 may be removably attachable to the mounting component 38. When the fuel tank 14 is mounted to the mounting component 38, the fuel output 24 of the fuel tank 14 may removably attach to the fuel input 36 of the fuel powered vehicle 12, and may therefore provide fuel to the fuel powered vehicle 12.

In certain embodiments, the fuel powered vehicle 12 may be a riding lawnmower 13. However, the fuel powered vehicle 12 is not limited to a riding lawnmower 13, and the present invention may be applied to any vehicle that is powered by fuel, such as the heavy equipment mentioned above. In certain embodiments, the fuel of the present invention may include gasoline.

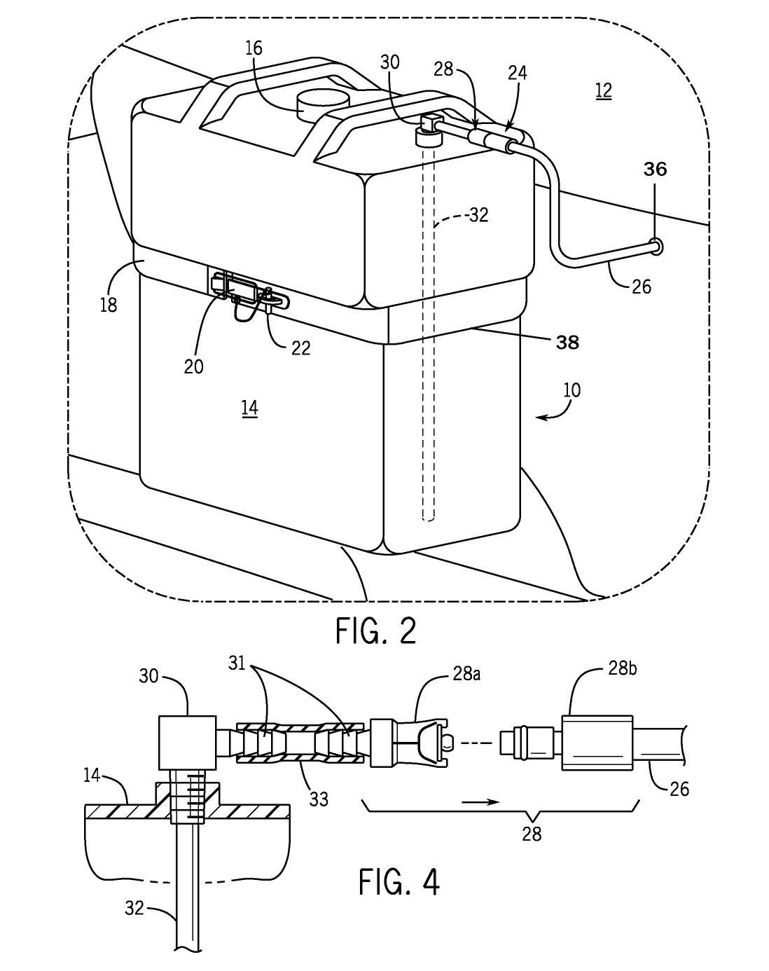

In certain embodiments, the mounting component 38 may include a mounting strap 18 to secure the fuel tank 14 to the fuel powered vehicle 12. The mounting component 38 may also include a fuel housing, enclosure, clips, snaps, and the like. As illustrated in FIG. 2, the mounting strap 18 may further include a latch 20 and a pin 22 to tightly secure the fuel tank 14 to vehicle 12.

As mentioned above, the fuel tank 14 may include a fuel output 24 which may connect with a fuel input 36 of the vehicle 12. In certain embodiments, the fuel output 24 may include a dip tube 32 that may run from inside the fuel tank 14 near the bottom to the outside surface near the top and attach to a fitting 30. The fitting 30 may include a barbed hose outlet 31. The fuel input 36 of the vehicle 12 may include a fuel line 26 that may connect with the fuel output 24. Therefore, the fuel line 26 may directly connect with the barbed hose outlet 31.

In certain embodiments, the present invention may further include a quick snap connection 28. The quick snap connection 28 may include a first connector 28a and a second connector 28b. The first connector 28a may be attached to the barbed hose outlet 31 by a tubing 33. The second connecter 28b may be attached to the fuel line 26. The first connector 28a and the second connector 28a may snap together and thereby connect the fuel input 36 with the fuel output 24.

A method of using the present invention may include the following. A user may obtain a freestanding fuel tank 14 and bring the fuel tank 14 to a fuel station. The user may remove the cap 16 from the fuel tank and fill the fuel tank 14 with fuel. The user may then bring the fuel tank 14 back to the vehicle 12, such as a lawn mower 13. The fuel tank 14 may be placed within the mounting strap 18 and the latch 20 may be closed and the pin 22 may secure the latch 20. Therefore, the tank 14 is secured to the vehicle 12. The second connector 28b of the fuel line 26 may connect with the first connector 28a of the fitting 30. Thereby, the fuel output 24 of the fuel tank 14 may connect with the fuel input 36 of the vehicle 12.

It should be understood, of course, that the foregoing relates to exemplary embodiments of the invention and that modifications may be made without departing from the spirit and scope of the invention as set forth in the following claims.

What is claimed is:

1. A removable fuel tank apparatus comprising:
a fuel powered vehicle comprising a fuel input;
a mounting component connected to the fuel powered vehicle; and
a fuel tank comprising a fuel output,
wherein the fuel tank is removably attachable to the mounting component, and wherein the fuel output of the fuel tank is removably attachable to the fuel input of the fuel powered vehicle.

2. The removable fuel tank apparatus of claim 1, wherein the fuel powered vehicle is a riding lawn mower.

3. The removable fuel tank apparatus of claim 1, wherein the mounting component comprises a mounting strap comprising a latch and a pin.

4. The removable fuel tank apparatus of claim 1, wherein the fuel is gasoline.

5. The removable fuel tank apparatus of claim 1, wherein the fuel output comprises a dip tube inside the fuel tank that runs from a bottom of the fuel tank and attaches to a fitting on the outside surface near a top of the fuel tank.

6. The removable fuel tank of apparatus of claim 5, further comprising a barbed hose attached to the fitting.

7. The removable fuel tank apparatus of claim 6, wherein the fuel input comprises a fuel line that removably connects with the barbed hose.

8. The removable fuel tank apparatus of claim 7, further comprising a quick snap connection comprising:
a first connector attached to the barbed hose outlet; and
a second connector attached to the fuel line,
wherein the first connector and the second connector are configured to snap together to attach and snap apart to split apart.

9. A method of attaching a fuel tank to a vehicle comprising:
filling a freestanding fuel tank with fuel;
attaching the fuel tank to a vehicle; and
connecting a fuel output of the fuel tank with a fuel input of the vehicle.

10. The method of claim 9, wherein the vehicle is a riding lawn mower.
